(19) United States
(12) Patent Application Publication
(10) Pub. No.: US 2016/0027234 A1
(43) Pub. Date: Jan. 28, 2016

(54) ONLINE MULTIPLAYER GAMING SYSTEMS AND METHODS

(71) Applicant: LTA Partners, LLC, St. Louis, MO (US)

(72) Inventors: Dan Reilly, St. Louis, MO (US); Dave Squires, Dardenne Prairie, MO (US); Jeff Hunter, Leesburg, VA (US)

(21) Appl. No.: 14/807,705

(22) Filed: Jul. 23, 2015

Related U.S. Application Data
(60) Provisional application No. 62/028,200, filed on Jul. 23, 2014.

(51) Int. Cl. G07F 17/32

(52) U.S. Cl. CPC G07F 17/323; G07F 17/3276; G07F 17/3288

(57) ABSTRACT

A computer implemented method for online multi-player games is provided. The method includes receiving game registration information for at least one game, receiving player registration information from at least one player for the at least one game, compiling a game board for the game, where the game board comprises a plurality of player selected spaces, where each selected space is associated with at least one value of a selected statistic for each entity of the competitive event, transmitting to each player at least one value of the selected statistic for each entity associated with each space selected by that player, receiving an actual value of the selected statistic for each entity from the associated competitive event, determining which space is associated with the actual value of the selected statistic for each entity, and transmitting a notification of winning the prize to the player with the determined space.

### CROSS REFERENCE TO RELATED APPLICATIONS

This application claims the benefit of U.S. Provisional Application No. 62/028,200 filed Jul. 23, 2014, which is hereby incorporated by reference in its entirety.

### BACKGROUND

People have been playing prediction games in an attempt for a player to select a number that is the closest to the score of an actual event to win a prize. These games take on a variety of forms including square pools. A square pool is game with a board with 10 rows and 10 columns. The rows are associated with one side of a competitive event (Team A) and the columns are associated with the other side of the competitive event (Team B). An organizer selects which statistic of the sporting event the game is played with, usually the score. Players select spaces on the board. When all of the players have selected their spaces, the organizer fills in numbers (0 through 9) to associate with each row and each column. The numbers are usually selected randomly. The numbers on the rows and columns are compared with the last digit of the selected statistic. For example, if the score of the game was Team A-67 to Team B-54 then the player in the space in the 7 row and the 4 column would win. These games can be played on most competitive sporting events, such as baseball, basketball, hockey, football etc.

### BRIEF DESCRIPTION OF THE DISCLOSURE

In one aspect, a computer implemented method for online multi-player games is provided. The method is implemented using a computing device having a processor communicatively coupled to a memory. The method includes receiving from a database a plurality of competitive events where each competitive event comprises two entities and receiving by the processor game registration information for at least one game. The at least one game is associated with one competitive event of the plurality of competitive events, and the game registration information includes a game identifier, a player space limit, a selected statistic, and at least one prize. The method also includes receiving player registration information from at least one player for the at least one game where the player registration information includes a player identifier, at least one player contact method, and one or more selected spaces, and compiling a game board for the game. The game board comprises a plurality of player selected spaces, where each selected space is associated with at least one value of the selected statistic for each entity of the competitive event. The method further includes transmitting to each player the at least one value of the selected statistic for each entity associated with each square selected by that player, receiving from the database an actual value of the selected statistic for each entity from the associated competitive event, determining by the processor which square is associated with the actual value of the selected statistic for each entity, and transmitting a notification of winning the prize to the player with the determined square.

### BRIEF DESCRIPTION OF THE DRAWINGS

FIGS. 1-29 show example embodiments of the methods and systems described herein.

FIG. 1 is a simplified block diagram of a game processing computing device in communication with a plurality of computer devices in accordance with one example embodiment of the present invention.

FIG. 2 illustrates an example configuration of a client device shown in FIG. 1, in accordance with one embodiment of the present disclosure.

FIG. 3 illustrates an example configuration of the game network server shown in FIG. 1, in accordance with one embodiment of the present disclosure.

FIG. 4 is a flowchart illustrating an example of the process of creating a game based on a competitive event using the system shown in FIG. 1, in accordance with one embodiment of the disclosure.

FIG. 5 is a flowchart illustrating an example process of registering players for and activating a game based on a competitive event using the system shown in FIG. 1, in accordance with one embodiment of the disclosure.

FIG. 6 is a flowchart illustrating an example process of running a game based on a competitive event using the system shown in FIG. 1, in accordance with one embodiment of the present disclosure.

FIG. 7 is a diagram of components of one or more example computing devices that may be used in the system shown in FIG. 1.

FIG. 8 is an example user interface on the game processing computing device displaying a login screen.

FIG. 9 is an example user interface on the game processing computing device displaying a sign up screen.

FIG. 10 is an example user interface on the game processing computing device displaying the available games.

FIG. 11 is an example user interface on the game processing computing device displaying competitive events to select for creating a game.

FIG. 12 is an example user interface on the game processing computing device displaying choosing a date for the competitive event list.

FIG. 13 is an example user interface on the GP computing device 124 displaying the information to be inputted for setting up a game.

FIG. 14 is an example user interface on the game processing computing device displaying how to select a square limit for the game.

FIG. 15 is an example user interface on the game processing computing device displaying choosing a prize from a list for the game being set-up.

FIG. 16 is an example user interface on the game processing computing device displaying adding a prize to the list of prizes.

FIG. 17 is an example user interface on the game processing computing device displaying choosing a filler square prize.

FIG. 18 is an example user interface on the GP computing device 124 displaying the prompt confirming saving the game.

FIG. 19 is an example user interface on the game processing computing device displaying a game board for a set-up game.

FIG. 20 is an example user interface on the game processing computing device displaying entering the e-mail address of a player to add to the game.

FIG. 21 is an example user interface on the game processing computing device displaying the auto fill option for quickly locating a player.

FIG. 22 is an example user interface on the game processing computing device displaying a prompt stating no player found and asking if the user wants to add a new player.

FIG. 23 is an example user interface on the game processing computing device displaying a form for registering a new player.

FIG. 24 is an example user interface on the game processing computing device displaying a scroll bar for entering the date of birth of the player.

FIG. 25 is an example user interface on the game processing computing device displaying a scroll bar for selecting the player's favorite sport.

FIG. 26 is an example user interface on the game processing computing device displaying a completed new player form.

FIG. 27 is an example user interface on the game processing computing device displaying the game board with squares the player has selected.

FIG. 28 is an example user interface on the game processing computing device displaying a prompt confirming that the organizer wants to close the game to new players and set-up the board.

FIG. 29 is an example user interface on the game processing computing device displaying the final game board after the game has been activated.

### DETAILED DESCRIPTION OF THE DISCLOSURE

The following detailed description describes embodiments of the disclosure by way of example and not by way of limitation. The description clearly enables one skilled in the art to make and use the embodiments of the disclosure. The description describes several embodiments, adaptations, variations, alternatives, and uses of the disclosure, including what is presently believed to be the best mode of carrying out the disclosure. The disclosure is described as applied to an example embodiment, namely, methods and systems for operating a multiplayer game that is based on a competitive event. More specifically, the disclosure describes a game processing (“GP”) computing device configured to receive game registration information for at least one game, receive player registration information from at least one player of the game, compile a game board for the game, transmit to each player the values of the selected statistic for each entity associated with each space selected by that player, receive from the database an actual value of the selected statistic for each entity from the associated competitive event, determine which space is associated with the actual value of the selected statistic for each entity, and transmit a notification of winning the prize to the player with the determined space.

As used herein, “game” refers to the game being played on the GP computing device among multiple players. The term “competitive event” refers to the event that the game is based on. By the way of example, the competitive event may be a sporting event such as a football game, and the “game” would be based on the outcome of the football game (i.e., competitive event).

In one embodiment, a game network server receives a plurality of competitive events for processing. The competitive events can include sporting events, such as football, baseball, and basketball games. Each competitive event in the plurality of competitive events includes at least the date and time of the competitive event, the category of the competitive event, and at least two of the competitors in the competitive event. The game network server stores these competitive events in a database. The GP computing device is in communication with the game network server. The GP computing device receives the plurality of competitive events stored in the database. The GP computing device receives game registration information from an organizer to create a game. The game registration data include a selection of a competitive event from the plurality of competitive events stored in the database, one or more prizes for the players of the game, and the statistic of the competitive event that the game is based on (e.g., score, rebounds, hits, shots on goal, etc.). The GP computing device receives player registration information from players for the game. Once GP computing device determines that the game is ready to play, either by reaching the maximum number of players or by receiving a message from the organizer, the GP device builds a game board for the game and notifies each player of numbers associated with the player's spaces on the game board. While the Figures in this application show the spaces as squares in the square pool game, spaces could be circles, triangles, or other shapes or images. During the competitive event, the GP computing device receives statistical information about the competitive event from the game network server. At one or more predetermined points in the competitive event, the GP computing device determines one or more players to receive a prize based on the player's spaces on the board and the statistical information. The GP computing device automatically transmits either the prize or a notification of winning the prize to the one or more determined players.

In another embodiment, when creating a game, the GP computing device displays to the organizer a list of competitive events from the database. The list of competitive events may be filtered by date, category, or other data desired by the organizer. The GP computing device receives, from the organizer, a selection of a competitive event to associate with the game. The GP computing device also receives a game title, a game size, a player space limit, a statistic to base the game on, and one or more prizes for the game from the organizer. When the GP computing device receives an activate game message from the organizer, the GP computing device deducts a credit from the organizer's account. The GP computing device also stores and activates the game. The GP computing device receives registration data from one or more players for the game. The registration data for each player may include an e-mail address, first and last name, a date of birth, a favorite competitive event category, a photo, and an avatar image. The GP computing device also displays a game board to the player and receives the player's selection for one or more spaces up to the player space limit. When the game is ready to play, the GP computing device builds a game board for the game. The GP computing device determines the selected spaces for each player and transmits a message to each player which includes the numbers associated with player's selected spaces (these numbers being randomly assigned to the rows and columns of the board), where each space is associated with one or more values of the statistic for the game (the statistic is also selected by the organizer). During the competitive event, the GP computing device receives statistical information about the competitive event from the game network server. At one or more predetermined points in the competitive event, the GP computing device determines one or more players to receive a prize based on the player's spaces on the board and the statistical information. The GP computing device automatically transmits the prize or a message announcing the prize to the one or more determined players. In another embodiment, the GP computing device queries the game network server to request the statistical information for the competitive event that the game is associated with.

In yet another embodiment, the GP computing device determines participation information for players in the database. The participation information for each player may include the number of times a player has played a game, what location the player has played each game, what category of game the player participates in, what prizes the player has played for, when the player plays games, and what prizes the player has received. The GP computing device determines future games that the player may want to participate in based on the participation information and transmits a message to the player about those determined future games.

In the example embodiment, the game is a square pool. A square pool is game with a board with 10 rows and 10 columns. The rows are associated with one side of a competitive event (Team A) and the columns are associated with the other side of the competitive event (Team B). The organizer selects which statistic of the competitive event the game is played with, usually the score. Players select spaces on the board. When all of the players have selected their spaces, the organizer fills in numbers (0 through 9) to associate with each row and each column. The numbers are usually selected randomly. The numbers on the rows and columns are compared with the last digit of the selected statistic. For example, if the score of the game was Team A-67 to Team B-54 then the player in the space in the 7 row and the 4 column would win. These games can be played on most competitive sporting events, such as, but not limited to, baseball, basketball, hockey, and football. Some competitive events that are more individual based may be based on the winner in each of the men's and women's categories. For example, for the Boston Marathon, last digit of the seconds for the winner of the men's and the women's categories could be used.

Some games could be smaller than 10 by 10, where the board could be 5 spaces by 5 spaces. In this case, each row and column is associated with two numbers instead of one. In the above example, one of the rows for Team A could be the numbers 2 & 7 and one of the columns for Team B could be the numbers 4 & 9. In this case, the player would win if the last digits of the score for Team A were either 2 or 7 and the last digits of the score for Team B were either 4 or 9.

The methods and systems described herein may be implemented using computer programming or engineering techniques including computer software, firmware, hardware, or any combination or subset. As disclosed above, at least one technical problem with prior systems is a need for systems that automatically build the board, notify players of their winning numbers, receive statistical information, determine which player won a prize, and notify that player of winning the prize. The systems and methods described herein address that technical problem. The technical effect of the systems and processes described herein is achieved by performing at least one of the following steps: (a) receiving from a database a plurality of competitive events, wherein each competitive event comprises two entities; (b) receiving by the processor game registration information for at least one game, wherein each game is associated with one competitive event of the plurality of competitive events, and wherein the game registration information includes a game identifier, a player space limit, a selected statistic, and at least one prize; (c) receiving player registration information from at least one player for the at least one game, wherein the player registration information includes a player identifier, at least one player contact method, and one or more selected spaces; (d) compiling a game board for the game, where the game board comprises a plurality of player selected spaces, where each selected space is associated with at least one value of the selected statistic for each entity of the competitive event; (e) transmitting to each player the at least one value of the selected statistic for each entity associated with each space selected by that player; (f) receiving from the database an actual value of the selected statistic for each entity from the associated competitive event; (g) determining, by the processor, which space is associated with the actual value of the selected statistic for each entity; and (h) transmitting a notification of winning the prize to the player with the determined space. The resulting technical effect is that systems automatically build the board, notify players of their winning numbers, receive statistical information, determine which player won a prize, and notify that player of winning the prize.

In one embodiment, a computer program is provided, and the program is embodied on a computer readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In a further embodiment, the system is run on an Android® environment (Android is a registered trademark of Google Inc. located in Mountain View, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer readable medium and utilizes a Structured Query Language (SQL) with a client user interface front-end for administration and a web interface for standard user input and reports. In another embodiment, the system is web enabled and is run on a business-entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

Furthermore, as used herein, the term “real-time” refers to at least one of the time of occurrence of the associated events, the time of measurement and collection of predetermined data, the time to process the data, and the time of a system response to the events and the environment. In the embodiments described herein, these activities and events occur substantially instantaneously.

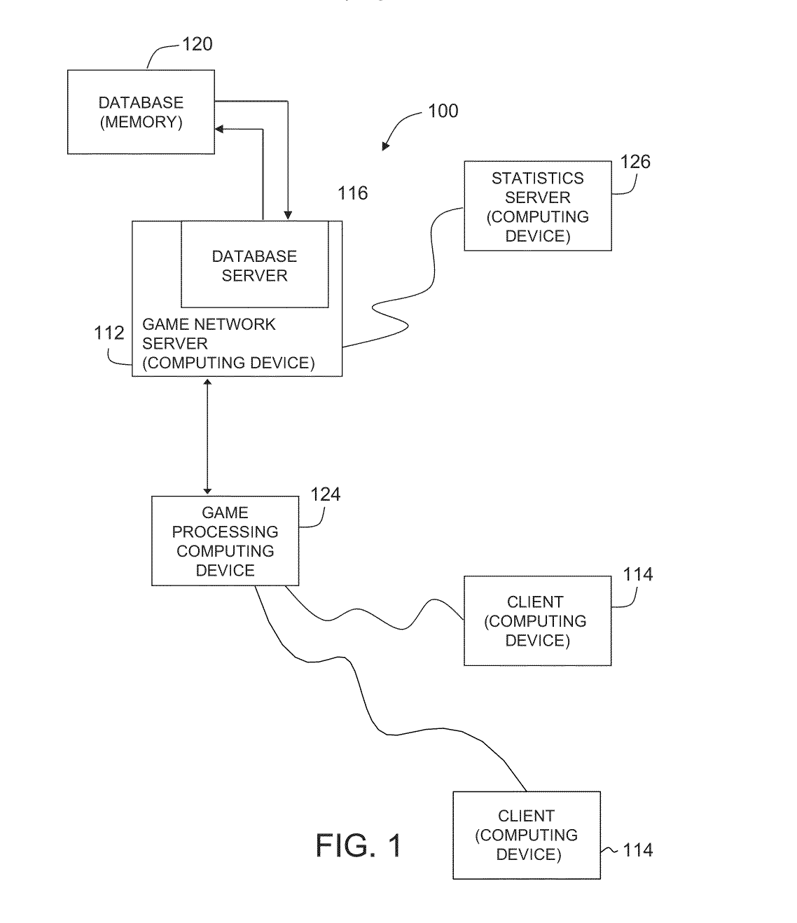

FIG. 1 is a simplified block diagram of a game processing computing device 124 in communication with a plurality of computer devices in accordance with one example embodiment of the present invention. In the example embodiment, system 100 is an on-line game system for multi-player games that includes a game processing (“GP”) computing device 124 configured to locally run a game with multiple players. As described below in more detail, GP computing device 124 is configured to receive game registration information from an organizer, receive player registration information from one or more players, compile a game board, determine which player won a prize, and notify the winning player.

A game network server 112 is communicatively coupled to the GP computing device 124. The game network server 112 is in communication with a statistics server 126. The statistics server 126 is may be one device or it may be a network of devices. The statistics server 126 provides the game network server 112 with data on competitive events, such as sporting events. This data can be for future competitive events such as the sides of the event, data and time, and category of the competitive event. The data can also be for currently occurring competitive events, where the data includes real-time statistical information on the competitive event. The data provided by the statistics server 126 can also be statistical information about competitive events that have occurred in the past. The statistical information provided can include, but is not limited to, scores, times, player numbers, rebounds, hits, shots on goal, errors, yards gains, yards to goal, time to completion, and any other statistical datum about the competitive event. The game network server 112 may request the information from the statistics server 126 or the game network server 112 may receive the data from the statistics server 126 at regular intervals. In some embodiments, the game network server 112 may be a part of or associated with the statistics server 126. In other embodiments, the game network server 112 is merely in communication with the statistics server 126.

A database server 116 is communicatively coupled to a database 120 that stores data. In one embodiment, database 120 includes competitive event data for future events, currently occurring events, and past events. Database 120 also may include organizer account information, such as credits remaining and current and past games. Database 120 further may include player account information, such as, first name, last name, e-mail address, phone number, date of birth, favorite competitive event category, photo, avatar image, links to games played in the past and links to games currently registered for. In the example embodiment, database 120 is stored remotely from game network server 112. In some embodiments, database 120 is decentralized. In the example embodiment, a person can access database 120 via game processing computing device 124 by logging onto game network server 112, as described herein.

The GP computing device 124 is communicatively coupled with the game network server 112. The GP computing device 124 can access the game network server 112 to store and access data. The GP computing device 124 can also communicate with the client devices 114. In the example embodiment, GP computing device 124 is a computer that includes a web browser or a software application, which enables GP computing device 124 to access game network server 112 using the Internet. More specifically, GP computing device 124 is communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. GP computing device 124 can be any device capable of accessing the Internet including, but not limited to, a desktop computer, a laptop computer, a personal digital assistant (PDA), a cellular phone, a smartphone, a tablet, a phablet, or other web-based connectable equipment. In some embodiments, the GP computing device 124 may be a part of or associated with the game network server 112. In other embodiments, the GP computing device 124 is merely in communication with the game network server 112.

Client devices 114 are computers that include a web browser or a software application, which enables client devices 114 to communicate with the GP computing device 124. More specifically, client device 114 is communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Client devices 114 can be any device capable of accessing the Internet including, but not limited to, a desktop computer, a laptop computer, a personal digital assistant (PDA), a cellular phone, a smartphone, a tablet, a phablet, or other web-based connectable equipment.

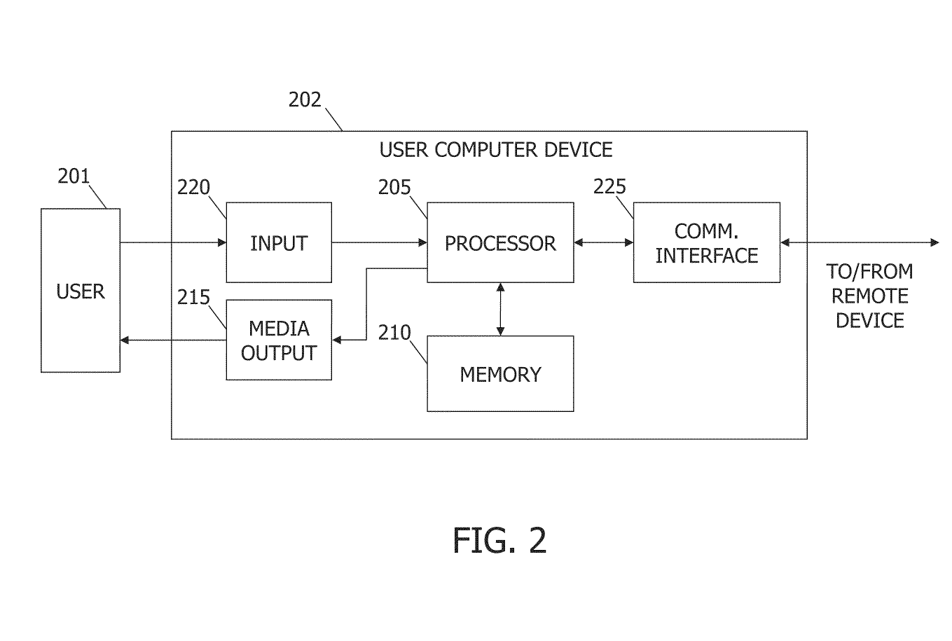

FIG. 2 illustrates an example configuration of a client device 114 shown in FIG. 1, in accordance with one embodiment of the present disclosure. User computer device 202 is operated by a user 201. User computer device 202 may include, but is not limited to, client devices 114 and GP computing device 124 (both shown in FIG. 1). User computer device 202 includes one or more processors 205 for executing instructions. In some embodiments, executable instructions are stored in to one or more memory areas 210. Processor 205 may include one or more processing units (e.g., in a multi-core configuration). Memory area 210 is any device allowing information such as executable instructions and/or transaction data to be stored and retrieved. Memory area 210 may include one or more computer readable media.

User computer device 202 also includes at least one media output component 215 for presenting information to user 201. Media output component 215 is any component capable of conveying information to user 201. In some embodiments, media output component 215 includes an output adapter (not shown) such as a video adapter and/or an audio adapter. An output adapter is operatively coupled to processor 205 and operatively coupleable to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 215 is configured to present a graphical user interface (e.g., a web browser and/or a client application) to user 201. A graphical user interface may include, for example, an online store interface for viewing and/or purchasing items, and/or a wallet application for managing payment information. In some embodiments, user computer device 202 includes an input device 220 for receiving input from user 201. User 201 may use input device 220 to, without limitation, select and/or enter one or more items to purchase and/or a purchase request, or to access credential information, and/or payment information. Input device 220 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 215 and input device 220.

User computer device 202 may also include a communication interface 225, communicatively coupled to a remote device such as game network server 112 (shown in FIG. 2) Server computer device 301 may include, but is not limited to, database server 116 (shown in FIG. 2) and GP computing device 124. Communication interface 225 may include, for example, a wired or wireless network adapter and/or a wireless data transceiver for use with a mobile telecommunications network.

Stored in memory area 210 are, for example, computer readable instructions for providing a user interface to user 201 via media output component 215 and, optionally, receiving and processing input from input device 220. A user interface may include, among other possibilities, a web browser and/or a client application. Web browsers enable users, such as user 201, to display and interact with media and other information typically embedded on a web page or a website from the game network server 112. A client application allows user 201 to interact with, for example, game network server 112. For example, instructions may be stored by a cloud service, and the output of the execution of the instructions sent to the media output component 215.

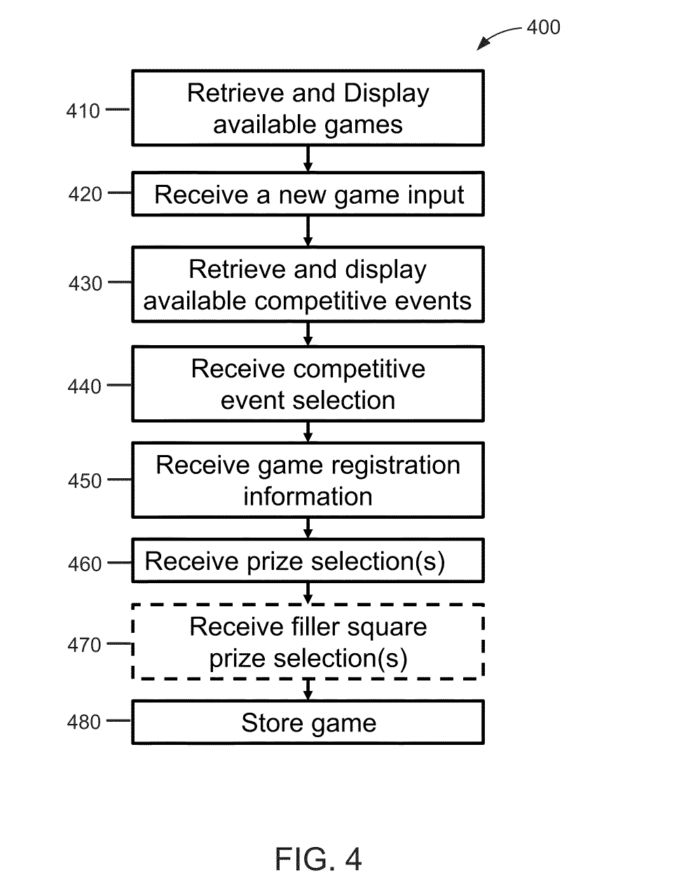

Processor 205 executes computer-executable instructions for implementing aspects of the disclosure. In some embodiments, the processor 205 is transformed into a special purpose microprocessor by executing computer-executable instructions or by otherwise being programmed. For example, the processor 205 is programmed with instructions such as illustrated in FIGS. 4-6.

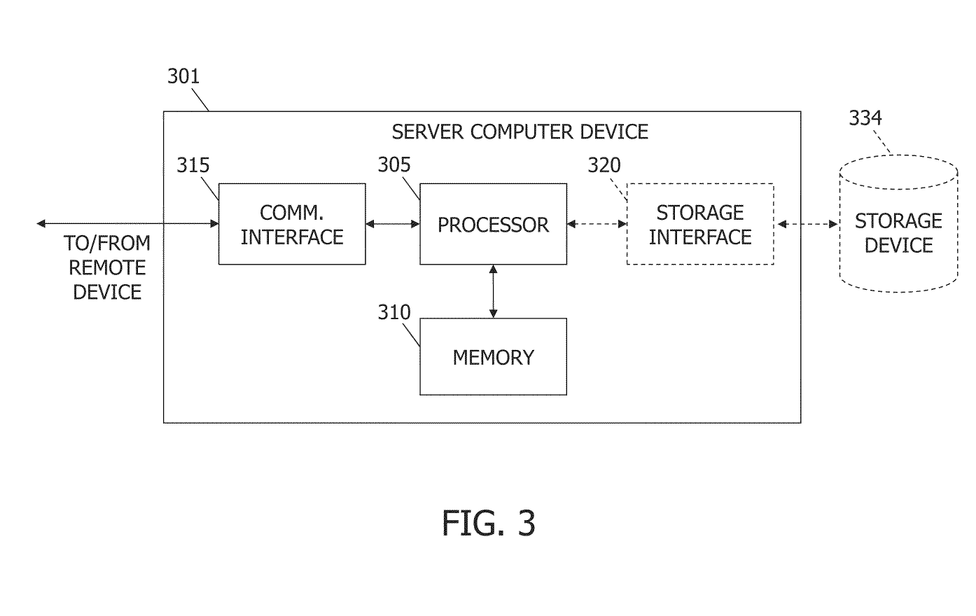

FIG. 3 illustrates an example configuration of the game network server 112 shown in FIG. 1, in accordance with one embodiment of the present disclosure. Server computer device 301 may include, but is not limited to, database server 116 and statistical server 126 (both shown in FIG. 1). Server computer device 301 also includes one or more processors 305 for executing instructions. Instructions may be stored in one or more memory areas 310. Processor 305 may include one or more processing units (e.g., in a multi-core configuration).

Processor 305 is operatively coupled to a communication interface 315 such that server computer device 301 is capable of communicating with a remote device such as another server computer device 301, statistics server 126, client devices 114, or GP computing device 124 (both shown in FIG. 1). For example, communication interface 315 may receive requests from GP computing device 124 via the Internet, as illustrated in FIG. 1.

Processor 305 may also be operatively coupled to a storage device 334. Storage device 334 is any computer-operated hardware suitable for storing and/or retrieving data, such as, but not limited to, data associated with database 120 (shown in FIG. 1). In some embodiments, storage device 334 is integrated in server computer device 301. For example, server computer device 301 may include one or more hard disk drives as storage device 334. In other embodiments, storage device 334 is external to server computer device 301 and may be accessed by a plurality of server computer devices 301. For example, storage device 334 may include a storage area network (SAN), a network attached storage (NAS) system, and/or multiple storage units such as hard disks and/or solid state disks in a redundant array of inexpensive disks (RAID) configuration.

In some embodiments, processor 305 is operatively coupled to storage device 334 via a storage interface 320. Storage interface 320 is any component capable of providing processor 305 with access to storage device 334. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 334.

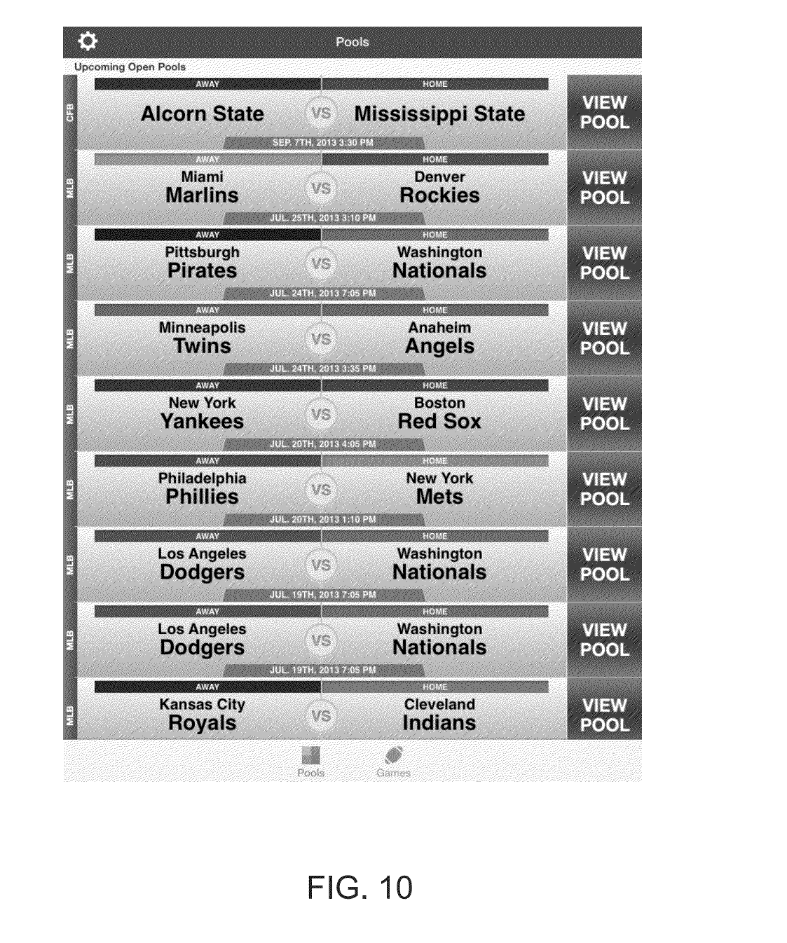

FIG. 4 is a flowchart illustrating an example of the process of creating a game based on a competitive event using the system shown in FIG. 1, in accordance with one embodiment of the disclosure. In the example embodiment, an event organizer logs in to the GP computing device 124, shown in FIG. 1. The GP computing device 124 retrieves and displays 410 all of the games that the organizer has created. In some embodiments, this list of games may be as shown in FIG. 10. In the example embodiment, each game is a square pool which is associated with a sporting event. In the example embodiments, the list of games is for sporting events that have not occurred yet. In other embodiments, the list of games may be for all of the games that the organizer has created. In some embodiments, the games are stored on the GP computing device 124, while in other embodiments, the games are stored in the database 120 (shown in FIG. 1) and the GP computing device 124 accesses the games through the game network server 112 (shown in FIG. 1).

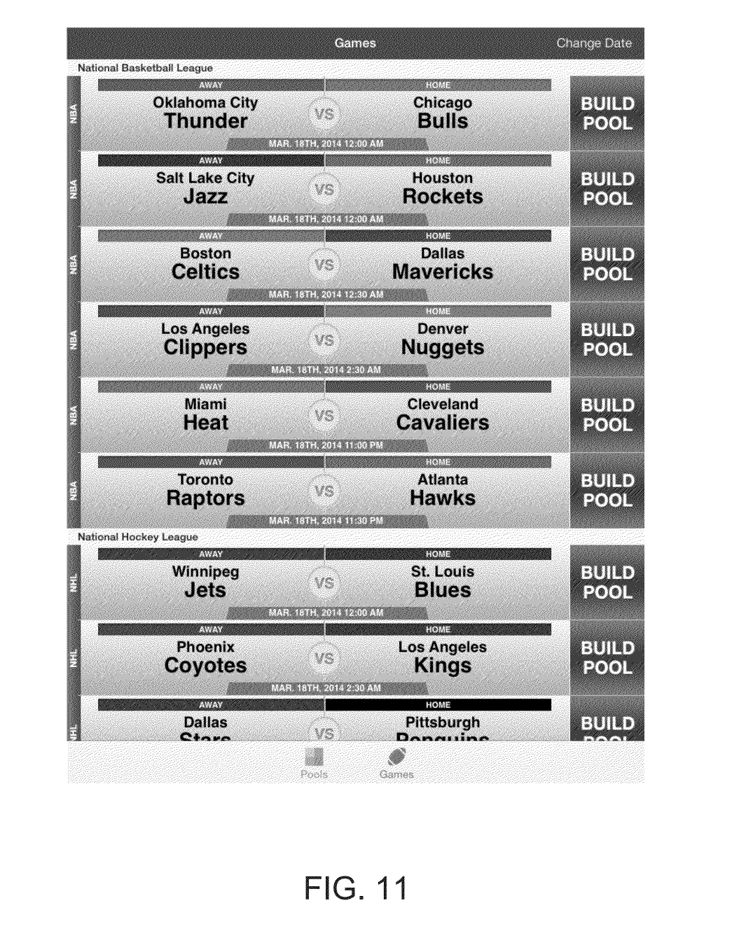

When the GP computing device 124 receives 420 an input to create a new game, the GP computing device 124 retrieves and displays 430 the available competitive events. In the example embodiment, the competitive events are sorted by sport as shown in FIG. 11. In the example embodiment, the competitive events are filtered to only show the competitive events occurring on one date at a time. The GP computing device 124 receives 440 the organizer's selection of a competitive event to create a game for. While in the example embodiment, the GP computing device 124 an input to create a new game is received before receiving the selection of the competitive event, in other embodiments, such as that shown in FIG. 11, the competitive event selection and create game input could be received simultaneously. Once the competitive event to create a game for has been selected, the GP computing device 124 receives 450 game registration information from the organizer. The game registration information may include a game title, a game size (for example some pools may be 5 spaces by 5 spaces while others are 10 spaces by 10 spaces), a player space limit (the maximum number of spaces a player may select), and a statistic to base the game on. The statistic that the game may be based on could be, for example, scores, times, player numbers, rebounds, hits, shots on goal, errors, yards gains, yards to goal, finish time, and any other statistical datum about the competitive event. The GP computing device 124 also receives 460 one or more prize selections. In the example embodiment, the prizes are to be given to a player whose space matches the last digit of the statistic at the appointed time in the competitive event. The prizes for the game could be a prize for winning at the end of the competitive event or for winning at any point in the competitive event, for example, at the end of a half, a quarter, or a period of the competitive event. In some embodiments, the GP computing device 124 receives 470 a prize for the filler space. A filler space, also known as a filler square, is any space that is not selected by a player when the game is closed to new players. If that space is the winning space, then the prize may be given to everyone at the location the game is occurring at. When the organizer is finished setting up the game, the GP computing device 124 receives an input and stores 480 the game. In some embodiments, the game is stored in the database 120, in other embodiments; the game is stored on the GP computing device 124.

In some embodiments, the organizer may be limited to the number of games that can be organized. This could be tracked by using credits, where the organizer's number of credits is reduced by one for every game that the organizer creates. This reduction in credits would be done as a part of step 480 when the game is stored.

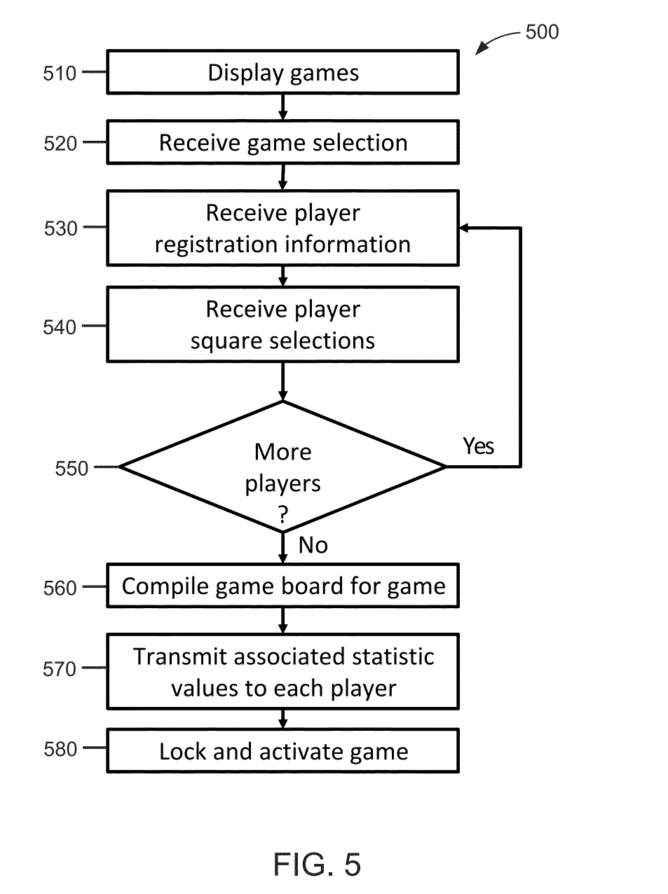

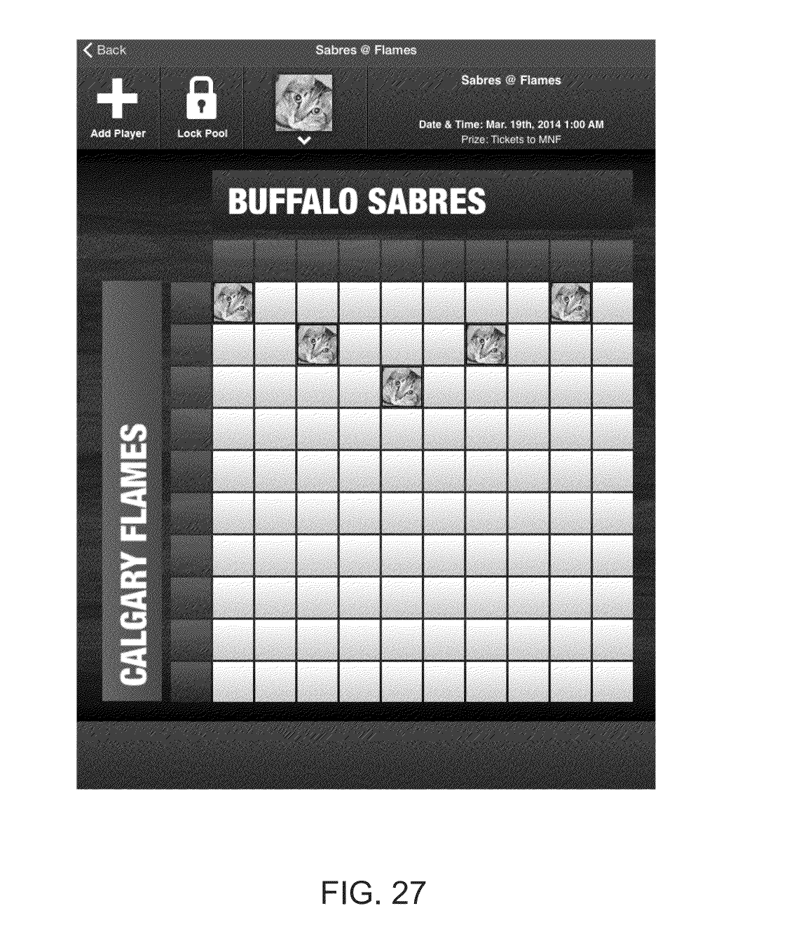

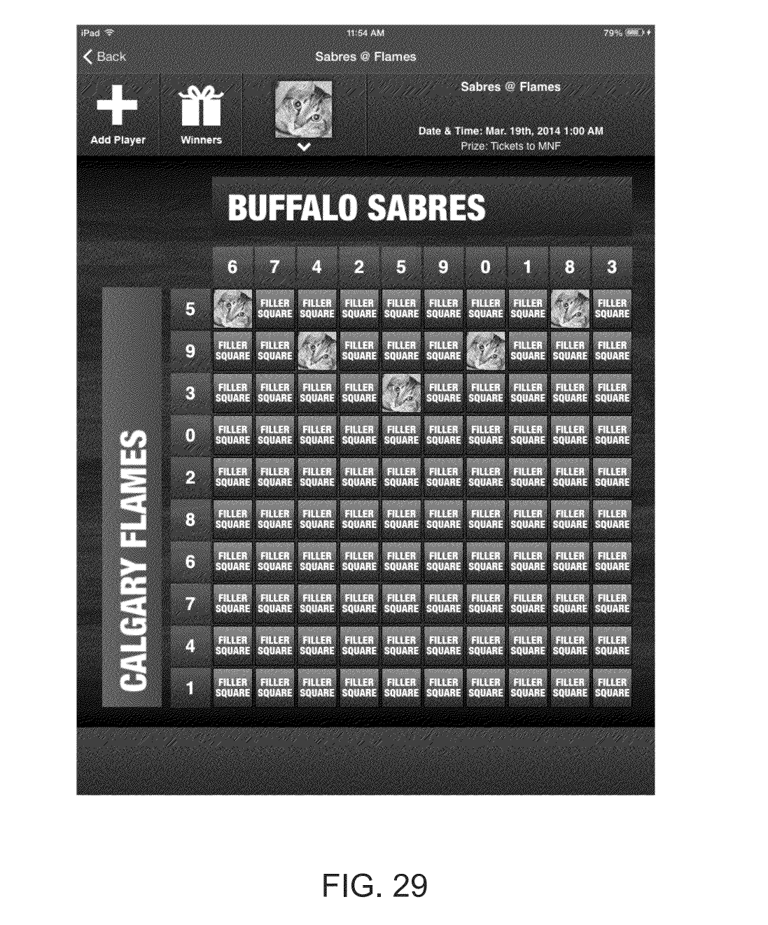

FIG. 5 is a flowchart illustrating an example process of registering players for and activating a game based on a competitive event using the system shown in FIG. 1, in accordance with one embodiment of the disclosure. In the example embodiment, the GP computing device 124 (shown in FIG. 1) displays 510 all of the created games for future competitive events. The GP computing device 124 receives 520 a selection of one of the created games. The GP computing device 124 displays the selected game and is ready to register players for the game. The GP computing device 124 receives 530 player registration information. The player registration information may be received by selecting a player from a list of pre-registered players or it may be by creating an account for a new player. The player registration information may include an e-mail address, a first and last name, a date of birth, a favorite competitive event category, a photo, and an avatar image. The GP computing device 124 receives 540 the player's space selections for the game. The player may select a number of spaces up to the player space limit. In some embodiments, the player space limit could be one, in other embodiments, the player space limit could be set by the game organizer or the GP computing device 124 based on the number of players. In the example embodiment, the player's avatar image is displayed in each space that the player selects as shown in FIG. 27. After each player has registered, the GP computing device 124 checks to see if there is room for more players 550. If yes, then the GP computing device 124 returns to step 530. Otherwise, the GP computing device 124 continues to step 560 to compile the game board. In some embodiments, the GP computing device 124 may receive an input from the organizer to close player registration and compile 560 the game board. When the game board is compiled 560, the GP computing device 124 randomly fills in numbers (from 0 to 9) for the rows and columns associated with the two entities in the competitive event. One example of a compiled board is shown in FIG. 29. The GP computing device 124 automatically transmits 570 to each registered player the statistic values associated with the spaces that the player selected. For example, the player in FIG. 29 would receive five sets of numbers (Sabres/Flames) 6/5, 4/9, 5/3, 0/9, and 8/3. In some embodiments, these are transmitted to the player via e-mail. In other embodiments, the numbers could be transmitted to the player's phone, i.e., via a text message (i.e, an SMS or MMS message). Additionally, in some embodiments, the GP computing device 124 is in communication with an application on the player's client device 114. In these embodiments, the GP computer device 124 may transmit an instruction to the client device 114 to display the numbers associated with the player's spaces. In still other embodiments, the GP computer device 124 may transmit the numbers via an instant message. Finally, the GP computing device 124 locks and activates the game 580. By locking the game, the GP computing device 124 prevents any other players registering for the game.

While in the example embodiment the GP computing device 124 is in direct communication with the user 201 (shown in FIG. 2) in some embodiments, the client device 114 (shown in FIG. 1) may perform the player registration process while in communication with the GP computing device 124. In these embodiments, the GP computer device 124 receives 520 game selection, receives 530 player registration information, and receives 540 player space selections from the user 201 via the client device 114. The GP computer device instructs the client device 114 to display 510 all of the games for future competitive events.

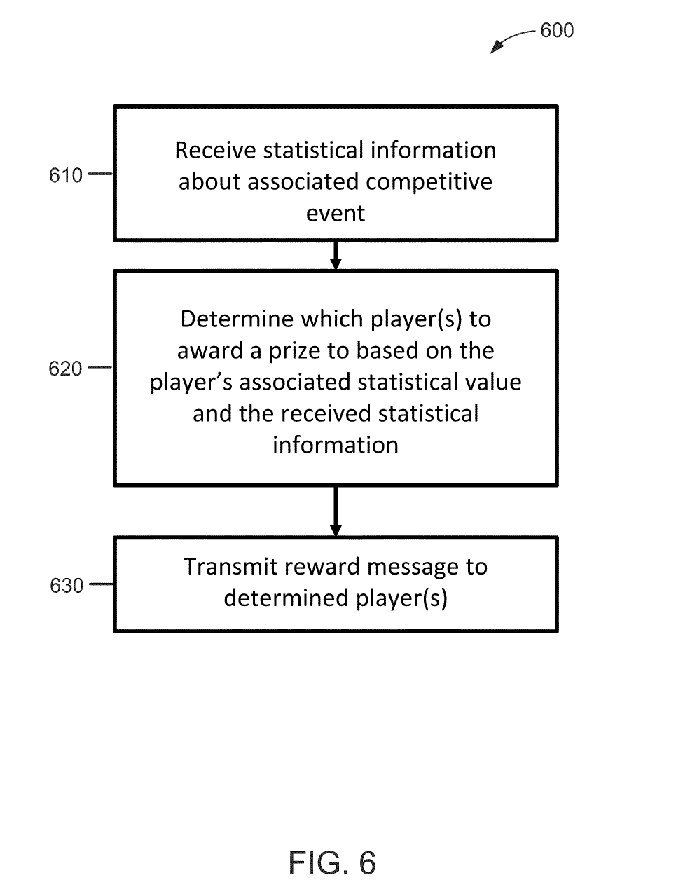

FIG. 6 is a flowchart illustrating an example process 600 of running a game based on a competitive event using the system shown in FIG. 1, in accordance with one embodiment of the present disclosure. In the example embodiment, once the competitive event begins the GP computing device 124 (shown in FIG. 1) receives statistical information about the game. In the example embodiment, this information is received at the game network server 112 from the statistics server 126 (both shown in FIG. 1). While in the example embodiment, the statistical information is received during the competitive event, in other embodiments, the statistical information could be received after the competitive event is over. From the statistical information about the competitive event, the GP computing device 124 determines 620 which player to award a prize to based on the statistical values associated with the player's space. In the example embodiment, the statistic that the game is based on is the score. For example, if at the end of the game the score was Sabres 10 Flames 9, then the GP computing device 124 takes the last digit of each of the scores and compares them to the game board as shown in FIG. 29. In this example, the player has the space associated with 0 for the Sabers and 9 for the Flames, so the GP computing device 124 would award a prize to that player. The GP computing device 124 transmits 630 a prize message to the determined player letting that player know that he won a prize. In other embodiments, the statistics may be checked at the end of a quarter, period, half, inning, etc. and the player whose space matches the last digit of each entity wins a prize.

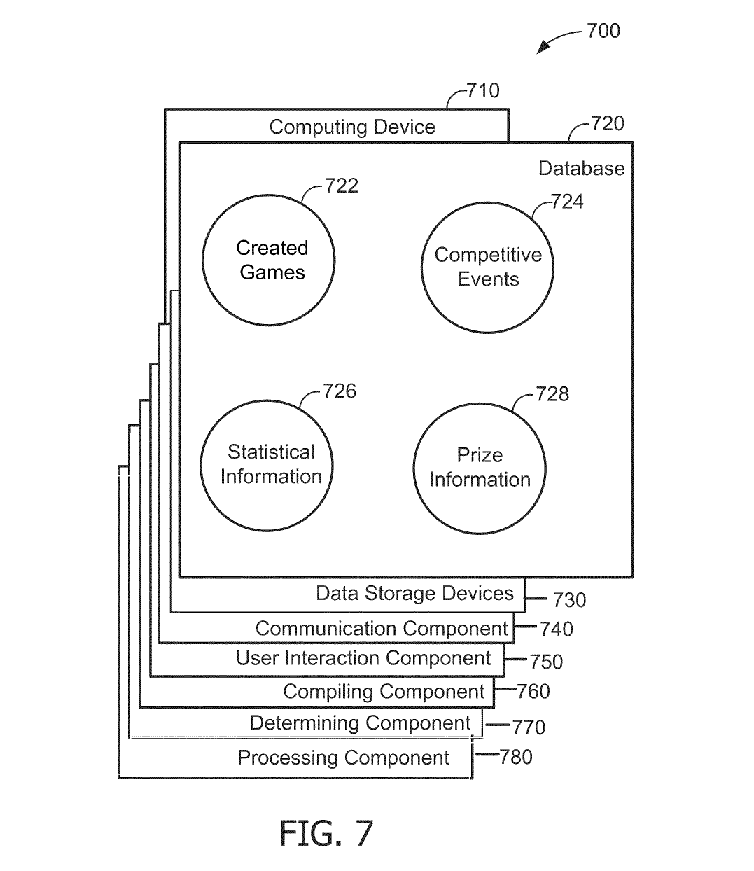

FIG. 7 is a diagram 700 of components of one or more example computing devices that may be used in the system 100 shown in FIG. 1. In some embodiments, computing device 710 is similar to game network server 112; it may also be similar to GP computing device 124 (both shown in FIG. 1). Database 720 may be coupled with several separate components within computing device 710, which perform specific tasks. In this embodiment, database 720 stores created games 722, competitive events 724, statistical information 726, and prize information 728.

Computing device 710 includes the database 720, as well as data storage devices 730. Computing device 710 also includes a communication component 740 for retrieving competitive events 430, retrieving games 410 (both shown in FIG. 4), receiving statistical information 610 (shown in FIG. 6), transmitting associated statistic values to each player 570 (shown in FIG. 5), and transmitting a prize message 630 (shown in FIG. 6). Communication component 740 may include, for example, a wired or wireless network adapter and/or a wireless data transceiver for use with a mobile telecommunications network. Computing device 710 also includes a user interaction component 750 for receiving player registration information 540, receiving player space selections 550 (both shown in FIG. 5), receiving new game input 420, receiving competitive event selection 440, receiving game registration information 450, and receiving prize selection 460 (all shown in FIG. 4). Computing device 710 further includes a compiling component 760 for compiling the game board 560 (shown in FIG. 5). Moreover, computing device includes a determining component 770 for determining which player to award a prize 620 (shown in FIG. 6). A processing component 780 assists with execution of computer-executable instructions associated with the system.

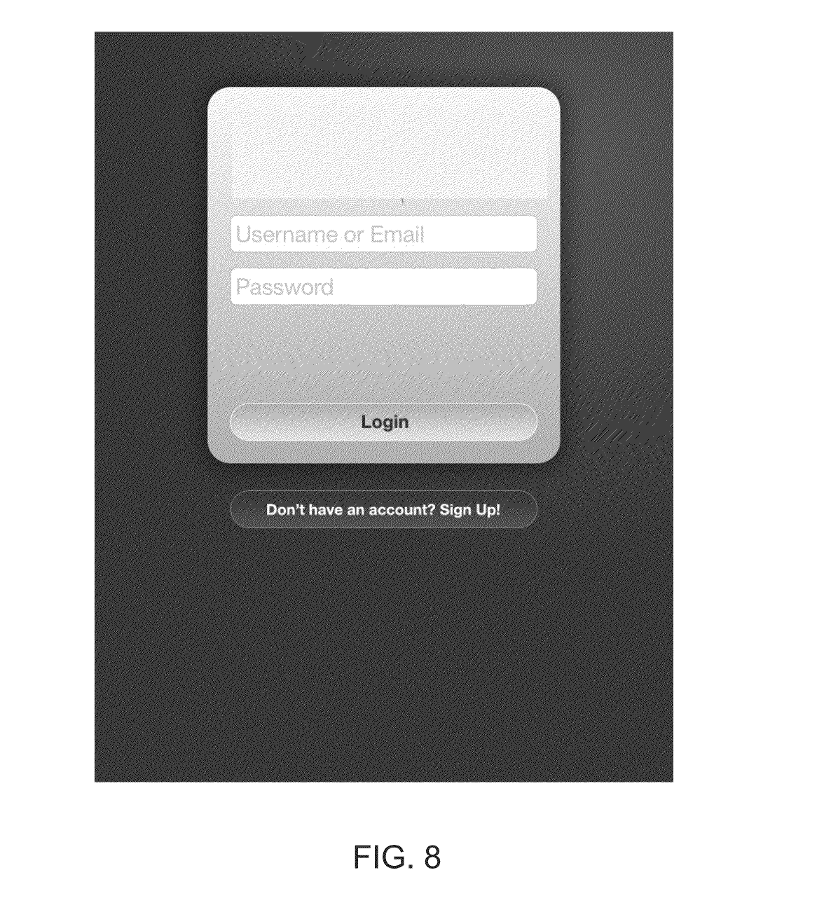

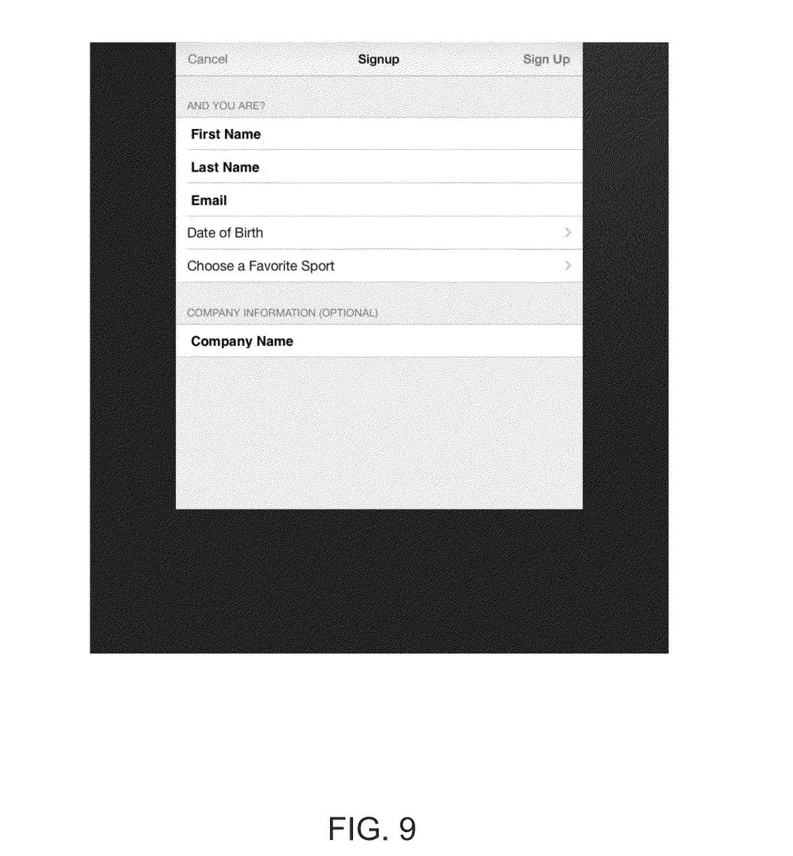

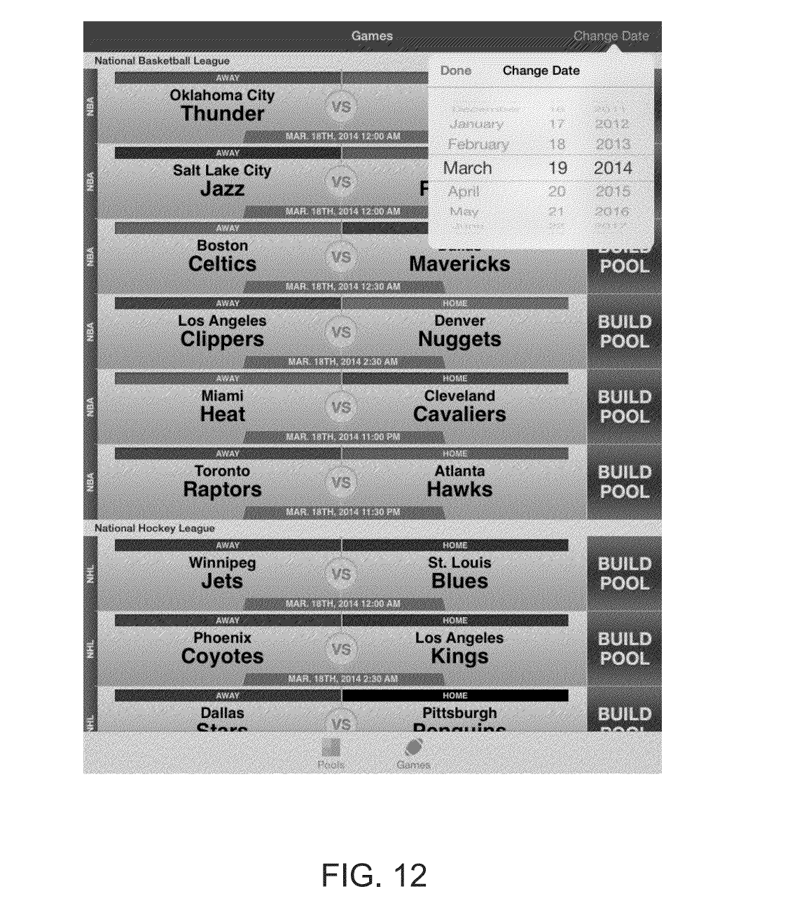

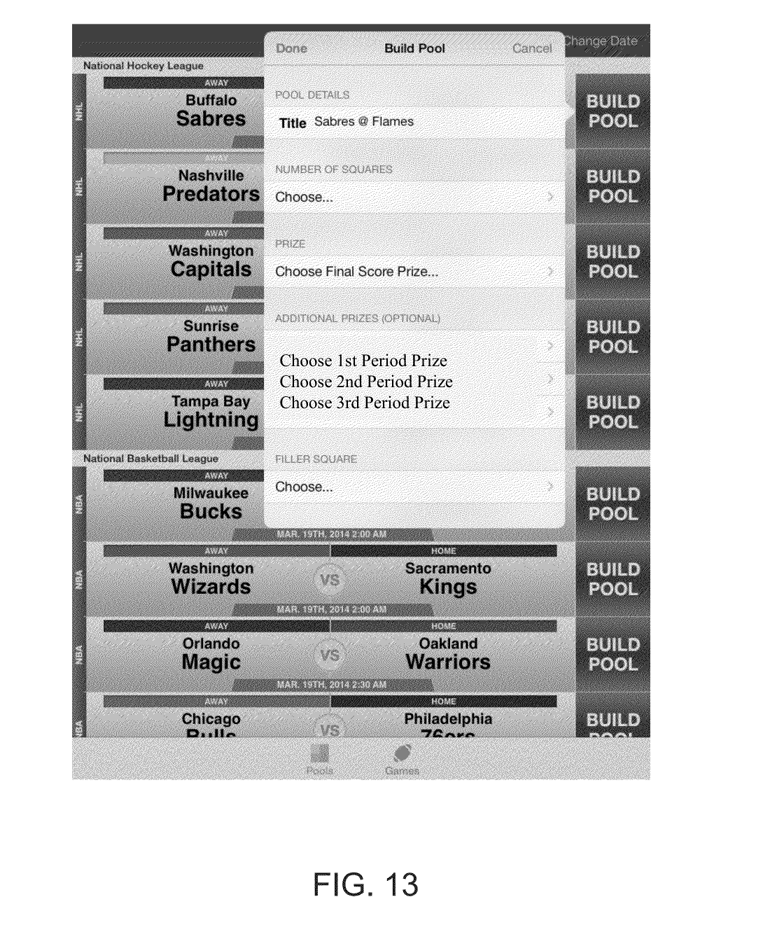

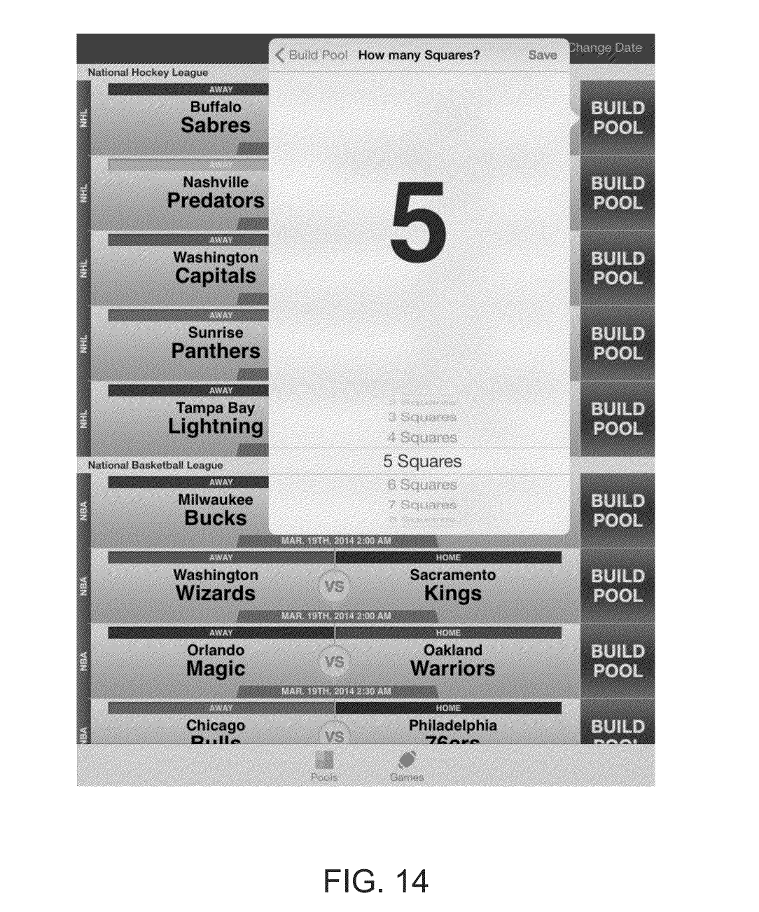

FIGS. 8-18 display different example user interfaces for setting up a game as described in process 400, shown in FIG. 4. FIG. 8 is an example user interface on the GP computing device 124 (shown in FIG. 1) displaying a login screen. The login screen is to allow a user 201 to login to the GP computing device 124. FIG. 9 is an example user interface on the GP computing device 124 displaying a sign up screen. User 201 may sign-up for an account with the GP computing device 124 if user 201 does not already have one. FIG. 10 is an example user interface on the GP computing device 124 displaying the available games. The displayed games are ones that user 201 has already set-up. From this screen user 201 can either select a game that is already loaded into the system from a prior set up or select a new game to use for pool. FIG. 11 is an example user interface on the GP computing device 124 displaying competitive events to select for creating a game. User 201 can select from any of the sports leagues which are loaded in the game network server 112, for example, but not limited to, NFL, NBA, and MLB. FIG. 12 is an example user interface on the GP computing device 124 displaying choosing a date for the competitive event list. The competitive event list will then show competitive events occurring on that date. FIG. 13 is an example user interface on the GP computing device 124 displaying the information to be inputted for setting up a game. FIG. 14 is an example user interface on the GP computing device 124 displaying how to select a space limit for the game. The space limit is the maximum number of spaces that each player is allowed to select.

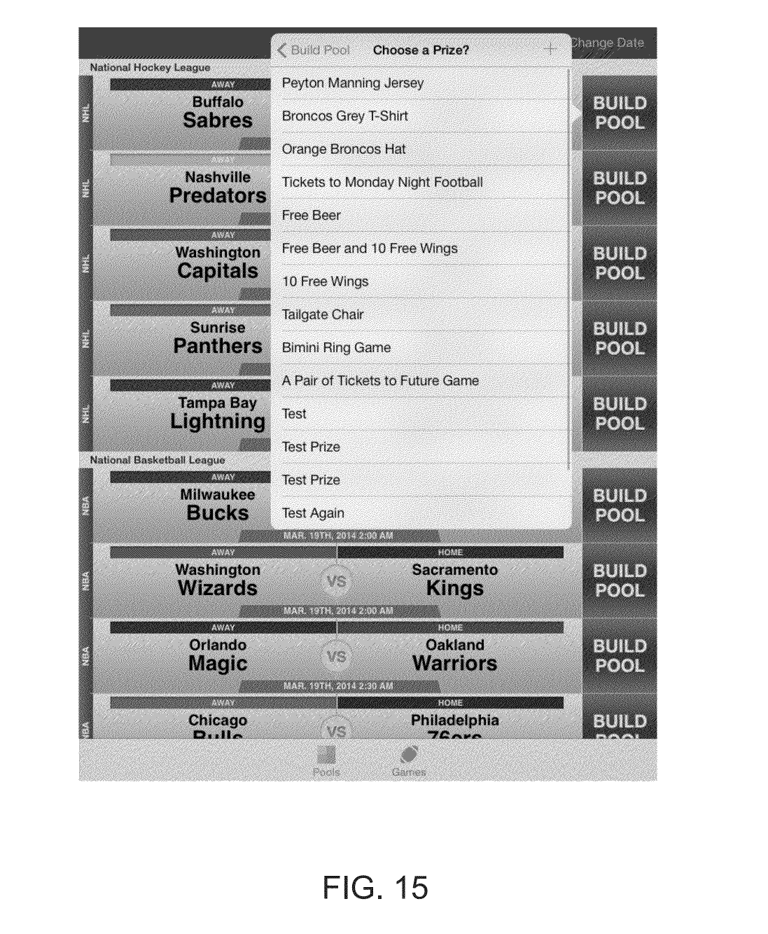

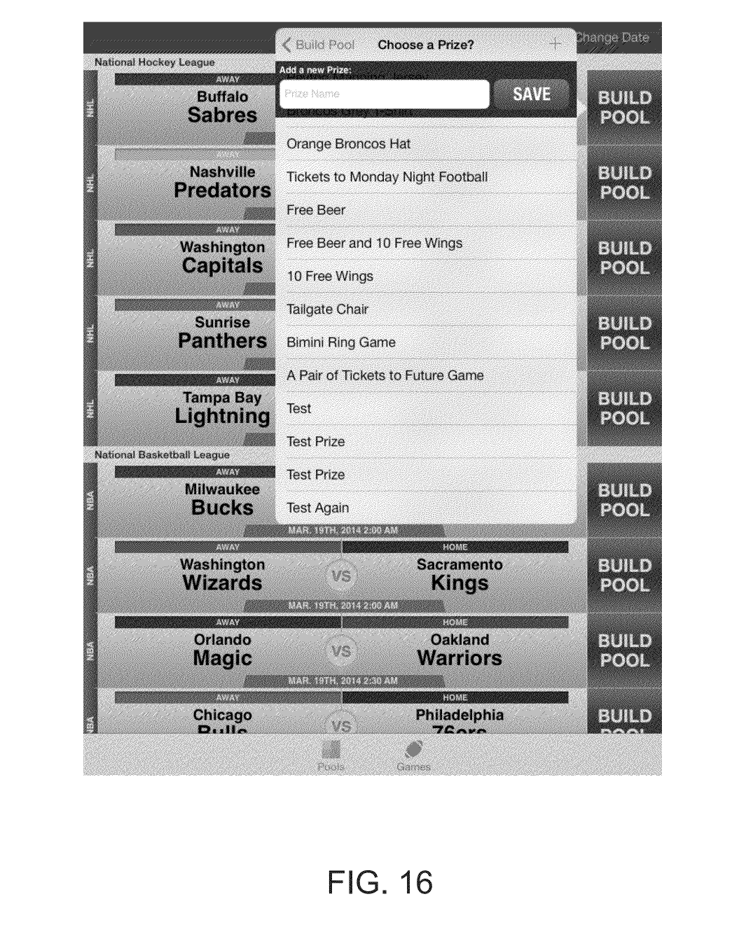

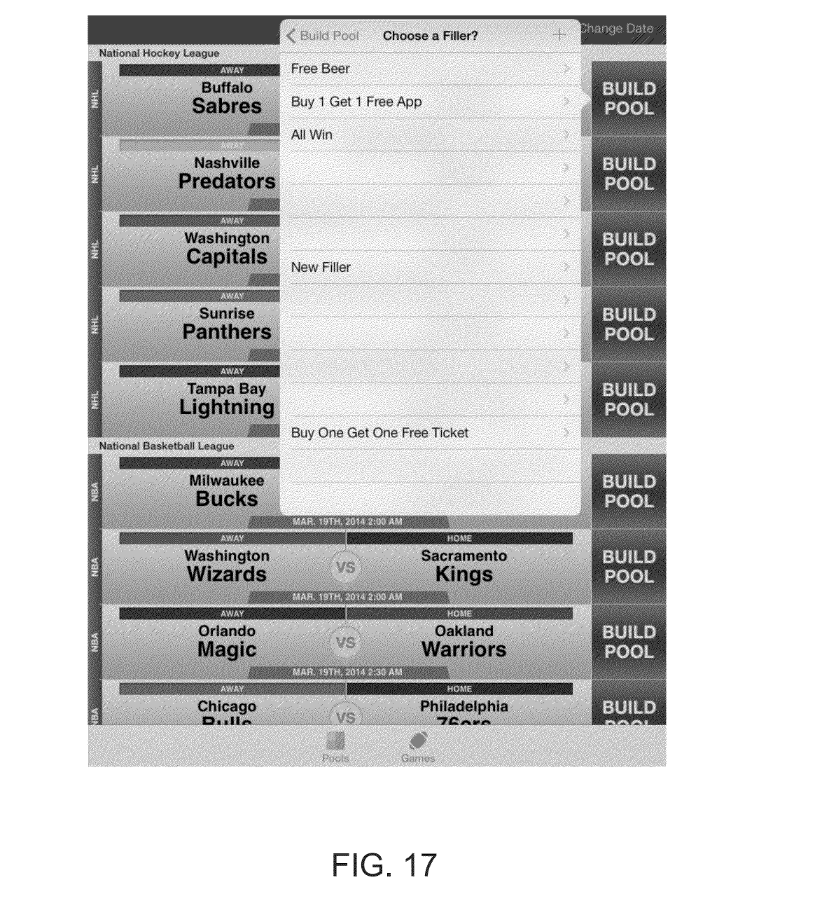

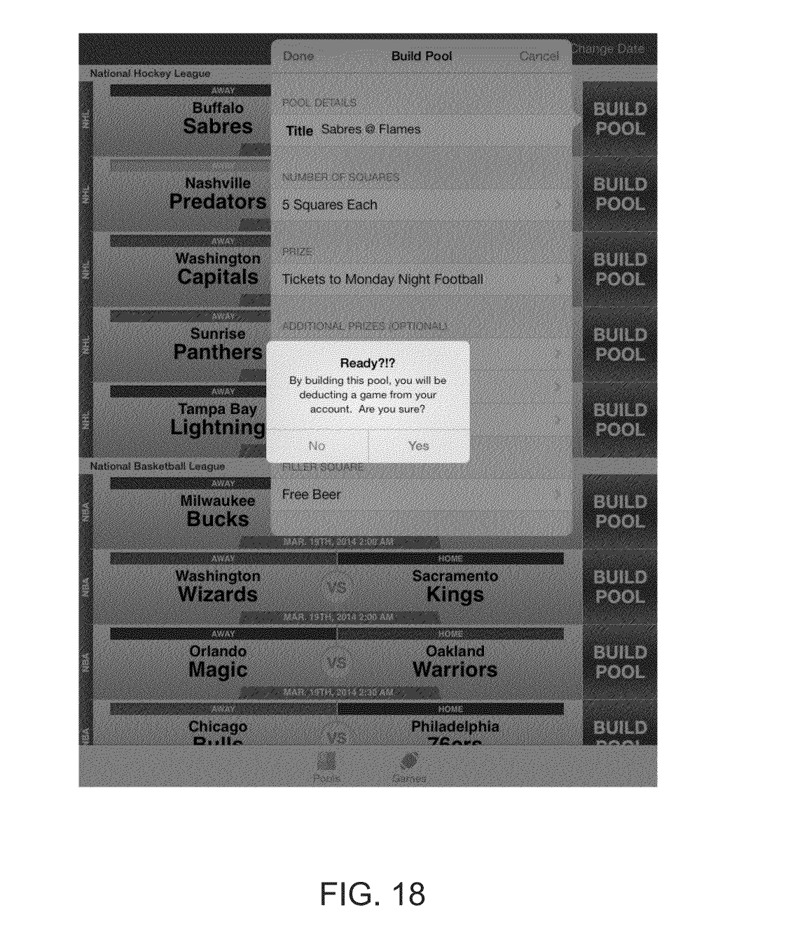

FIG. 15 is an example user interface on the GP computing device 124 displaying a screen for the organizer to choose a prize from a list for the game being set-up. FIG. 16 is an example user interface on the GP computing device 124 displaying adding a prize to the list of prizes. FIG. 17 is an example user interface on the GP computing device 124 displaying choosing a filler space prize. The filler space prize is for spaces that have not been selected by players of the game. In one embodiment, the filler space prize is awarded to everyone that it at the location the game is being played. FIG. 18 is an example user interface on the GP computing device 124 displaying the prompt confirming saving the game.

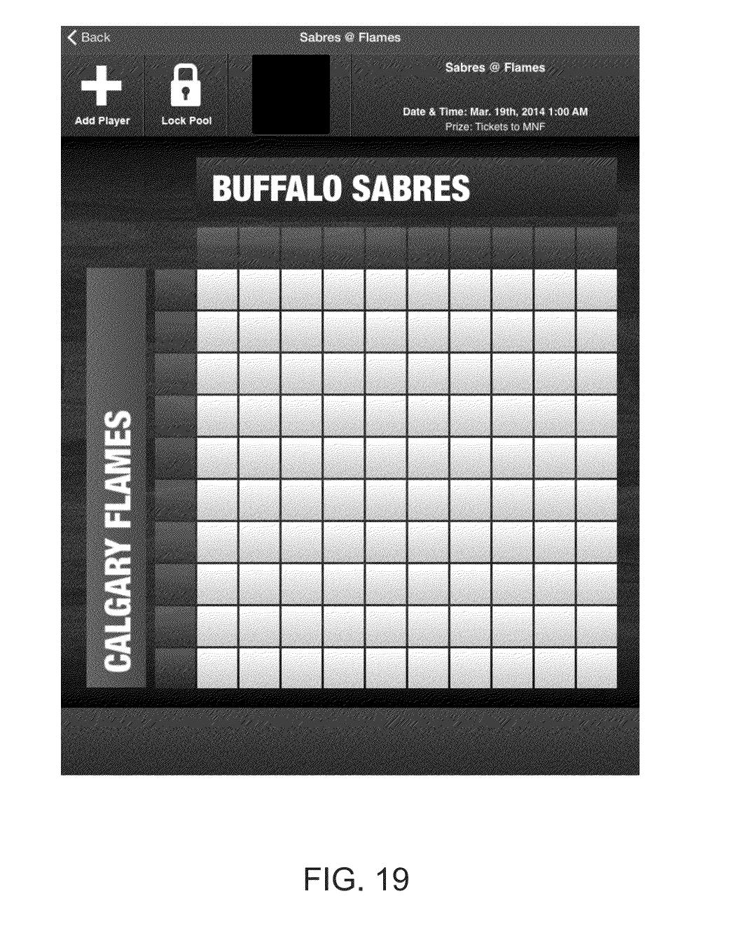

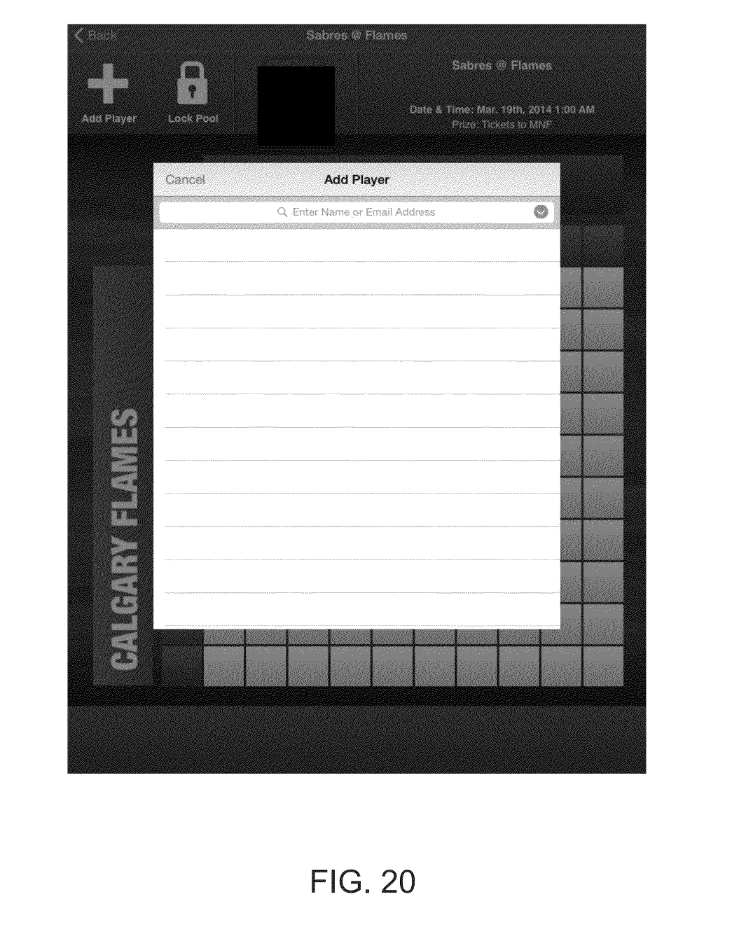

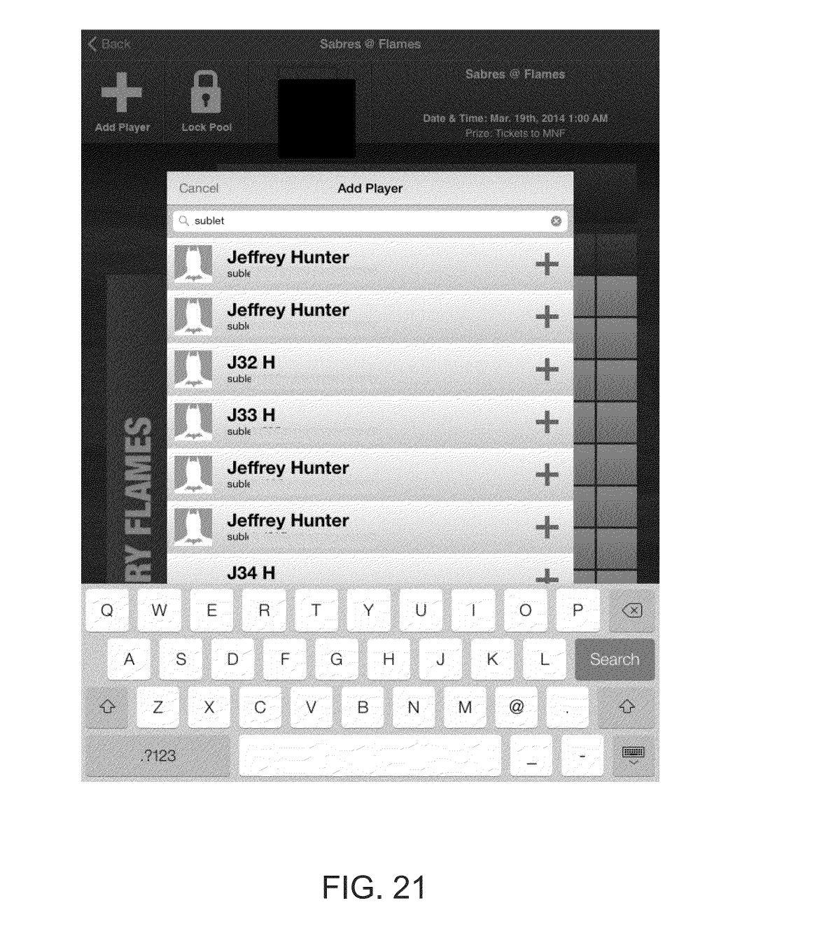

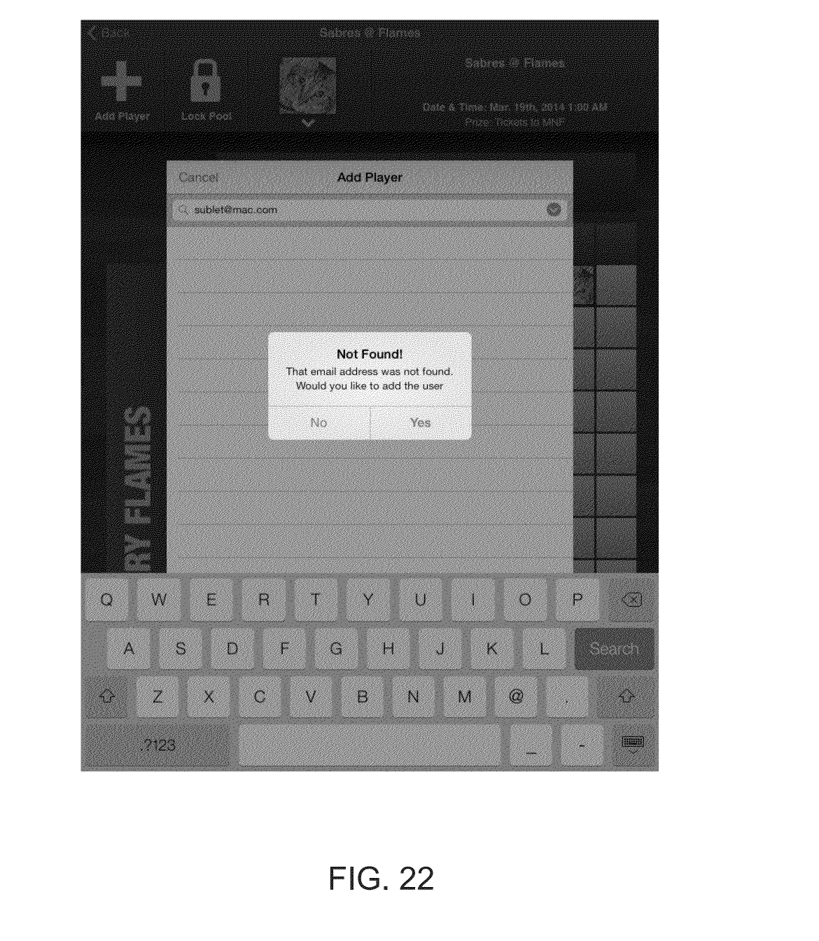

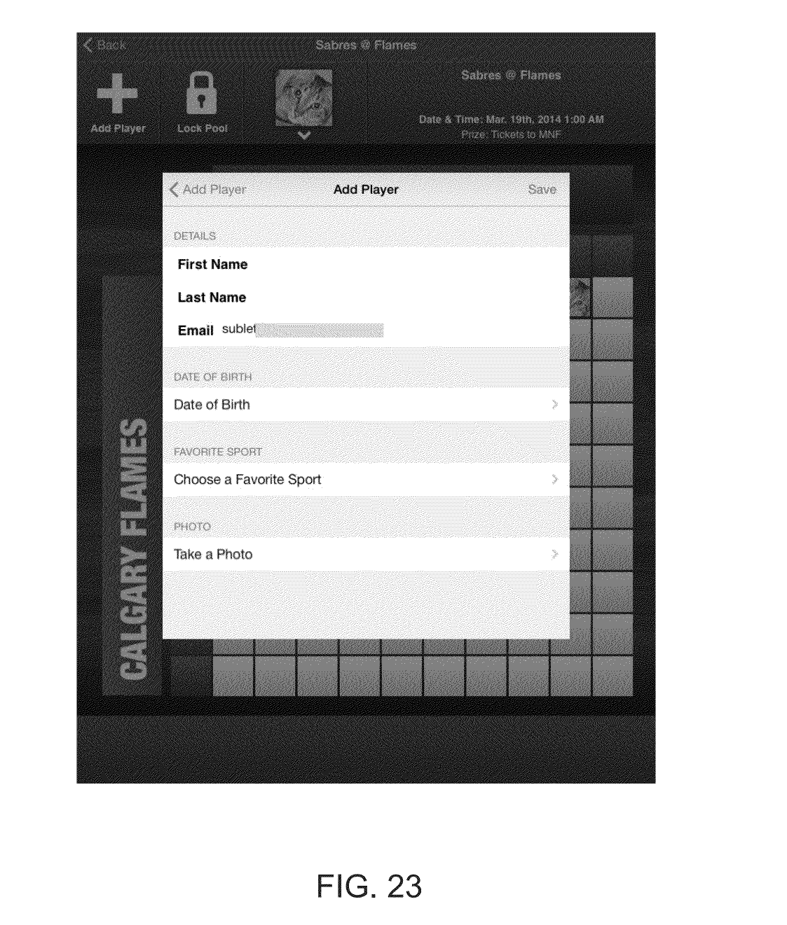

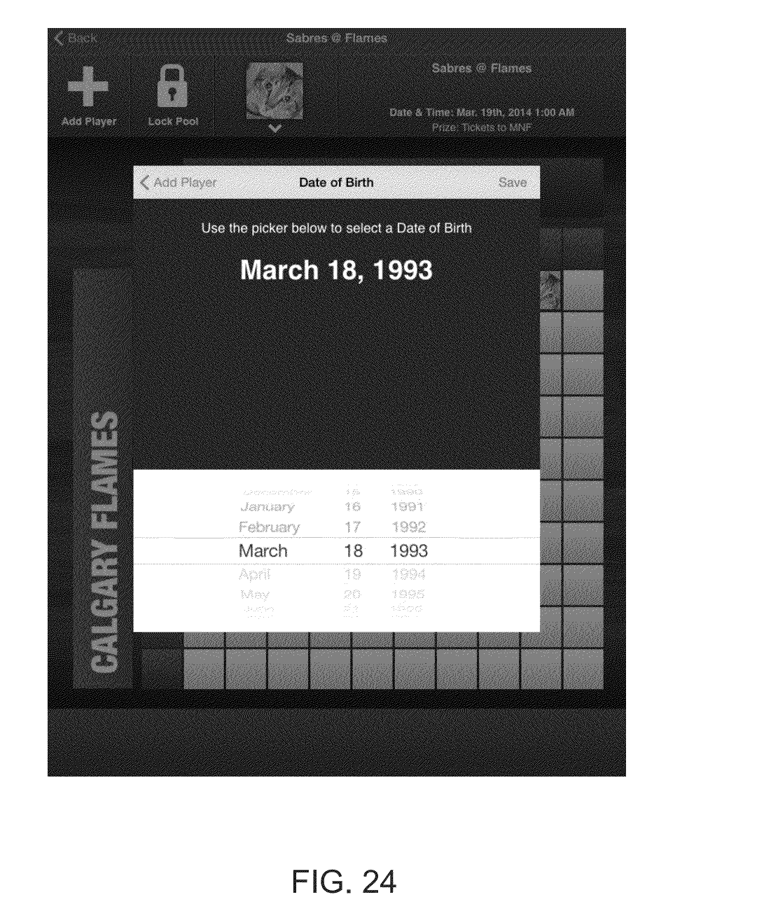

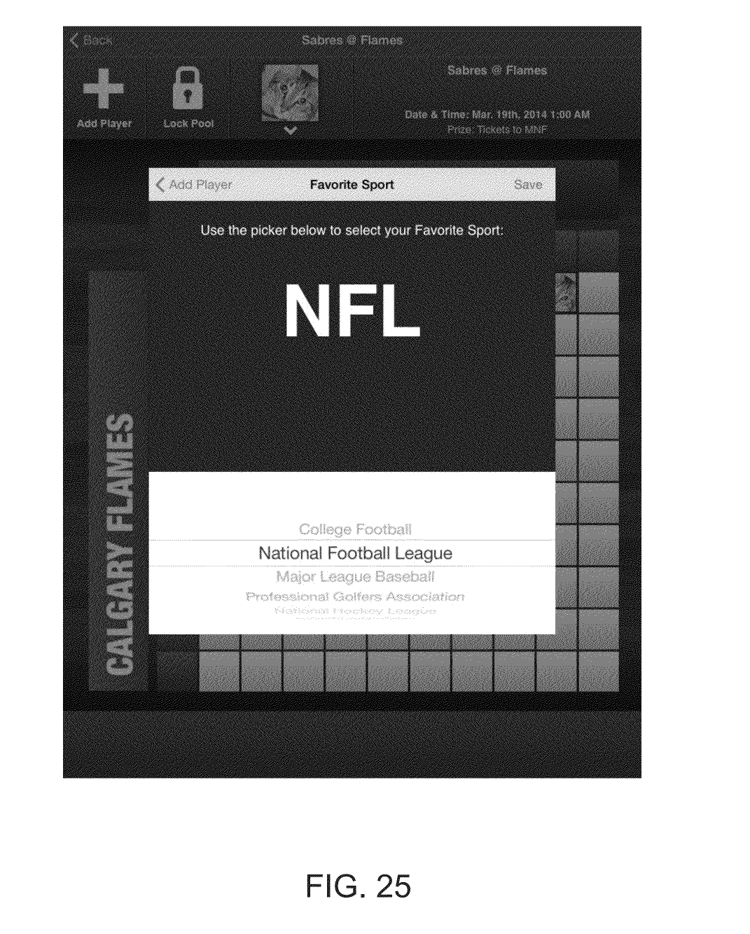

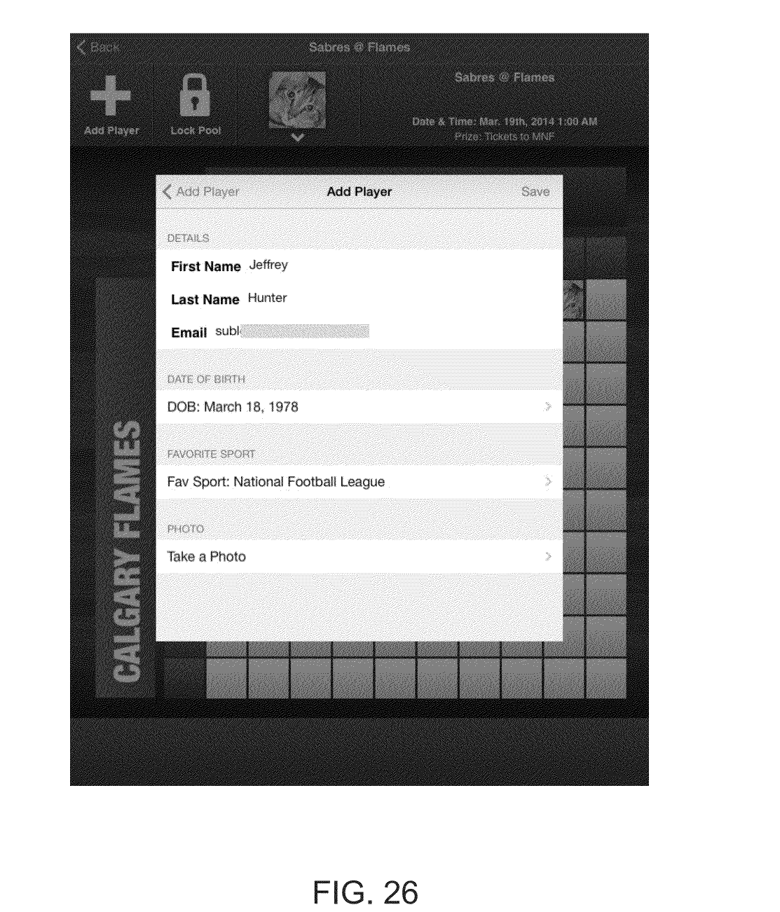

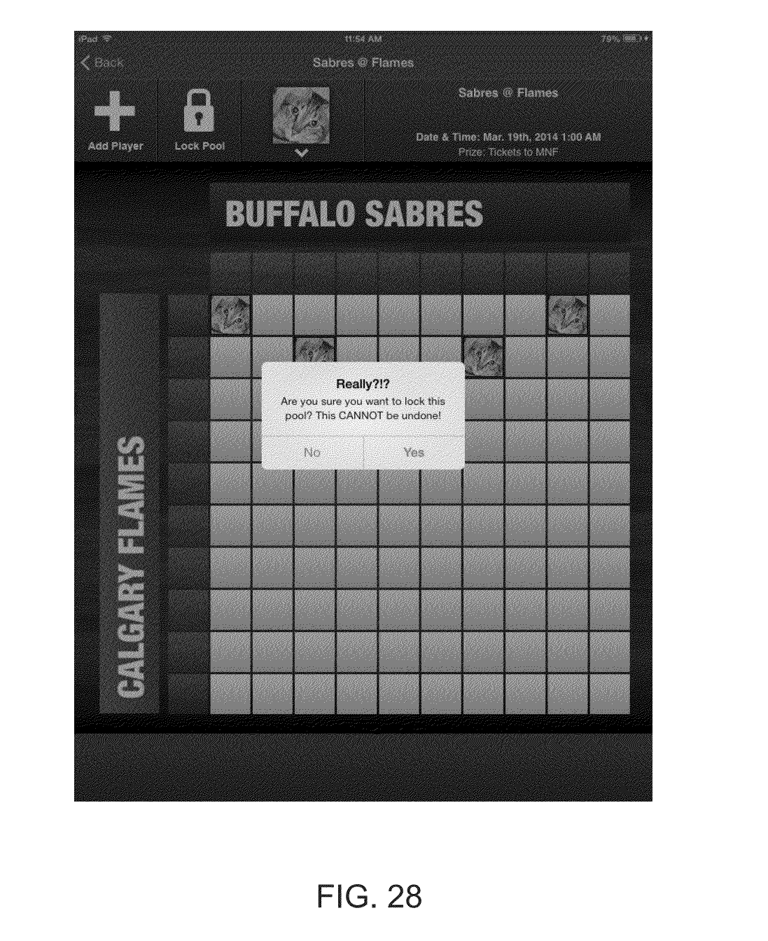

FIGS. 19-29 display different example user interfaces for registering players and activating a game as described in process 500, shown in FIG. 5. FIG. 19 is an example user interface on the GP computing device displaying a game board for a set-up game. FIG. 20 is an example user interface on the GP computing device 124 displaying entering the e-mail address of a player to add to the game. FIG. 21 is an example user interface on the GP computing device 124 displaying the auto fill option for quickly locating a player. The auto fill option retrieves player information from game network server 112 of players who have registered for games in the past. FIG. 22 is an example user interface on the GP computing device 124 displaying a prompt stating that no player was found and asking if the user wants to add a new player. FIG. 23 is an example user interface on the GP computing device 124 displaying a form for registering a new player. FIG. 24 is an example user interface on the GP computing device 124 displaying a scroll bar for entering the date of birth of the player. FIG. 25 is an example user interface on the GP computing device 124 displaying a scroll bar for selecting the player's favorite sport. FIG. 26 is an example user interface on the GP computing device 124 displaying a completed new player form. FIG. 27 is an example user interface on the GP computing device 124 displaying the game board with spaces the player has selected. FIG. 28 is an example user interface on the GP computing device 124 displaying a prompt confirming that the organizer wants to close the game to new players and set-up the board. FIG. 29 is an example user interface on the GP computing device 124 displaying the final game board after the game has been activated.

The systems and processes are not limited to the specific embodiments described herein. In addition, components of each system and each process can be practiced independent and separate from other components and processes described herein. Each component and process also can be used in combination with other assembly packages and processes.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A computer implemented method for online multi-player games, said method using a computing device having a processor communicatively coupled to a memory, said method comprising:
generating a game based on a competitive event;
receiving player space selections from a plurality of players for the game;
compiling a game board for the game, where the game board comprises a plurality of player selected spaces, where each selected space is associated with at least one value of a selected statistic for two entities of the competitive event;
transmitting to each player the at least one value of the selected statistic for each entity associated with each space selected by that player;
receiving an actual value of the selected statistic for each entity from the associated competitive event;
determining, by the processor, which space is associated with the actual value of the selected statistic for each entity; and
transmitting a notification of winning the prize to the player with the determined space.

2. The method in accordance with claim 1, wherein generating a game based on a competitive event further comprises:
receiving, from a database, a plurality of competitive events, wherein each competitive event comprises at least two entities; and
receiving, by the processor, game registration information for the game, wherein the game is associated with one competitive event of the plurality of competitive events.

3. The method in accordance with claim 2, wherein the game registration information includes a game identifier, a player space limit, a selected statistic, and at least one prize.

4. The method in accordance with claim 1, wherein the player registration information includes a player identifier, at least one player contact method, and one or more selected spaces.

5. The method in accordance with claim 1, wherein the processor transmits the at least one value of the selected statistic and the notification of winning the prize via at least one of, an email, a text message, or an instant message.

6. The method in accordance with claim 1, further comprises:
receiving a temporary value of the selected statistic for each entity from the associated competitive event for the selected statistic, wherein the temporary values represent the selected statistic at a predetermined period of time during the competitive event;
determining, by the processor, which space is associated with the temporary value of the selected statistic for each entity; and
transmitting a notification of winning the prize to the player with the determined space.

7. The method in accordance with claim 1, further comprising:
determining that the space associated with the actual values of the selected statistic is not associated with a player;
determining a lesser prize; and
transmitting a notification of the lesser prize to the plurality of players of the game.
